(19) United States
(12) Patent Application Publication
(10) Pub. No.: US 2012/0031365 A1
(43) Pub. Date: Feb. 9, 2012

(54) Intake manifold and seal

(76) Inventor: David J. Schweiger, Pewaukee, WI (US)

(21) Appl. No.: 12/806,281

(22) Filed: Aug. 9, 2010

(51) Int. Cl. F02M 35/10

(52) U.S. Cl. 123/184.21

(57) ABSTRACT

A manifold assembly is provided having an engine manifold, a mounting collar, and a resilient seal. The mounting collar is disposed on the engine manifold and the resilient seal is disposed between the engine manifold and the mounting collar. The engine manifold has an inlet, an outlet, and a primary protuberance formed on an outer surface of the engine manifold. The mounting collar has a secondary protuberance and is disposed on the engine manifold. The resilient seal is disposed between the engine manifold and the mounting collar. The primary protuberance abuts the secondary protuberance. The manifold assembly for an engine minimizes a required number of components, minimizes a time of assembly of the manifold assembly, and militates against a rotation of the engine manifold.

### FIELD OF THE INVENTION

The present invention relates to an engine manifold and a mounting collar for the engine manifold having a resilient seal disposed between the mounting collar and the engine manifold.

### BACKGROUND OF THE INVENTION

Manifold assemblies typically include at least one seal to militate against an escape of intake gases and exhaust gases. An engine manifold typically compresses a seal disposed between the engine manifold and a cylinder head. The engine manifold is urged towards the cylinder head by a mounting collar disposed on the engine manifold. An adjustable fastener coupling the mounting collar to the cylinder head permits an urging force to be varied. Upon compression of the seal, the engine manifold is rigidly coupled to the cylinder head, and little relative movement between the engine manifold and the cylinder head is afforded. Such manifold assemblies require a plurality of components, undesirably increasing the complexity of the manifold assembly.

Coupling the manifold assembly including the plurality of components may become an arduous or a time consuming task. A positioning of the seal with respect to the cylinder head and the engine manifold, an alignment of the adjustable fasteners and the mounting collar, application of nuts, washers, and thread locking fluid, and the urging force of each fastener must be given particular attention during assembly to ensure proper sealing between the cylinder head and the engine manifold. The engine manifold having a plurality of manifold inlets or a plurality of manifold outlets further complicates coupling the engine manifold to the cylinder head, as simultaneous attention must be given to each of the manifold inlets or each of the manifold outlets. The plurality of components of the manifold assembly undesirably increases an assembly time and an amount of required component manipulation during assembly of the manifold assembly.

It is common for portions of an engine assembling process to occur in a plurality of locations. Partially assembled engines and non-operational assembled engines may be transported within a facility or to another facility for further assembly or installation. During transportation of the partially assembled engines and non-operational assembled engines, engine components may move in an undesirable manner. Particularly, the engine manifold may rotate with respect to the cylinder head during transportation of the partially assembled engines and non-operational assembled engines. A rotation of the engine manifold during transportation may result in damage to the seal disposed between the cylinder head and the engine manifold. Further, correction of a positioning of the engine manifold may result in an undesirable increase in a duration of the engine assembling process.

It would be advantageous to utilize a manifold assembly for an engine that minimizes a required number of components, minimizes a time of assembly of the manifold assembly, and militates against a rotation of an engine manifold.

### SUMMARY OF THE INVENTION

Presently provided by the invention, a manifold assembly for an engine that minimizes a required number of components, minimizes a time of assembly of the manifold assembly, and militates against a rotation of an engine manifold, has surprisingly been discovered.

In one embodiment, the present invention is directed towards a manifold assembly for an engine having an engine manifold, a mounting collar, and a resilient seal. The mounting collar is disposed on the engine manifold and the resilient seal is disposed between the engine manifold and the mounting collar.

The engine manifold has an inlet, an outlet, and a primary protuberance formed on an outer surface of the engine manifold. The primary protuberance is formed adjacent the outlet of the engine manifold.

The mounting collar has a secondary protuberance. The mounting collar is disposed on the engine manifold adjacent the outlet of the engine manifold.

The resilient seal is disposed between the engine manifold and the mounting collar. The primary protuberance abuts the secondary protuberance to militate against a rotation of the engine manifold with respect to the mounting collar.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is an exploded perspective view of a manifold assembly for an engine according to an embodiment of the present invention;

FIG. 2 is a fragmentary perspective view of the manifold assembly illustrated in FIG. 1, a mounting collar of the assembly coupled to a cylinder head;

FIG. 3 is a cross-sectional, top elevational view of the manifold assembly shown in FIG. 1, taken along section line 3-3 in FIG. 2; and

FIG. 4 is a cross-sectional, top elevational view of a manifold assembly according to another embodiment of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

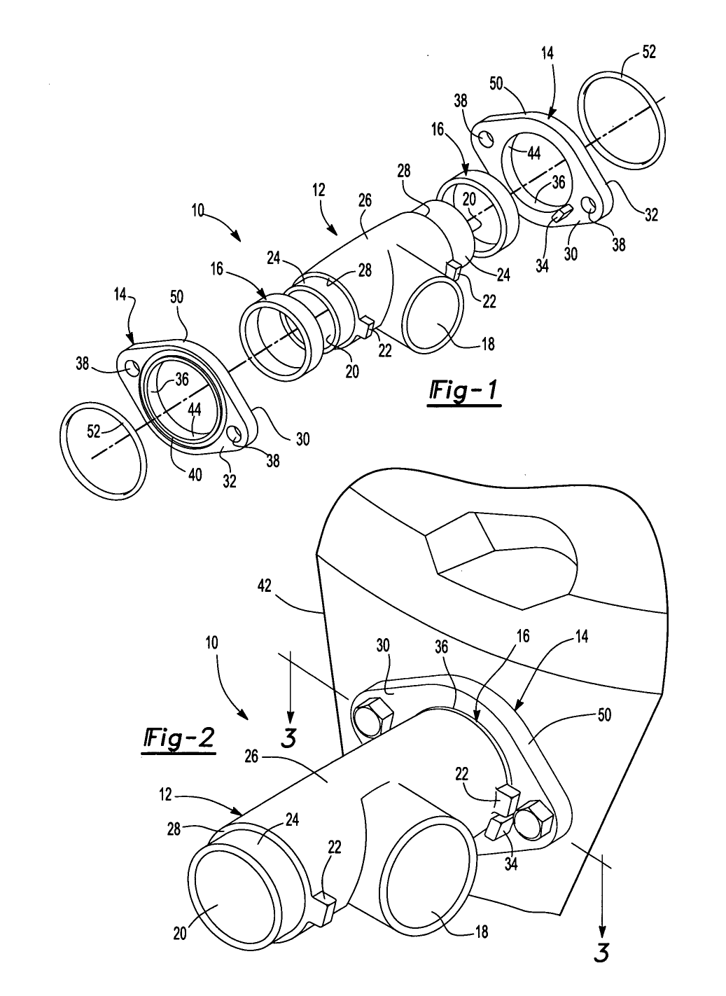

FIGS. 1-3 illustrate a manifold assembly 10 for an engine according to an embodiment of the present invention. The manifold assembly 10 includes an engine manifold 12, a mounting collar 14, and a resilient seal 16. As shown, the manifold assembly 10 is an intake manifold assembly, but the manifold assembly 10 may be an exhaust manifold assembly.

The engine manifold 12 has an inlet 18, at least one outlet 20, and a primary protuberance 22. The engine manifold 12 is typically formed by casting a metal such as aluminum, but other processes such as machining or forging may be used to form the engine manifold 12. As illustrated, the engine manifold 12 is a hollow body having one inlet 18 and two outlets 20. However, any number of inlets and outlets may be formed in the engine manifold. A cross-sectional shape of the engine manifold 12 adjacent the inlet 18 and the outlets 20 is substantially ring shaped. Alternately, other cross-sectional shapes such as rectangles, ellipses, or other closed shapes may be used.

A portion of the engine manifold 12 adjacent the at least one outlet 20 has a diameter less than a remaining portion of the engine manifold 12, forming a stepped portion 24. The stepped portion 24 is formed in an outer surface 26 of the engine manifold 12 adjacent the at least one outlet 20 of the engine manifold 12. Alternately, the engine manifold 12 may be tapered to form the portion of the engine manifold 12 having a diameter less than a remaining portion of the engine manifold 12 and a stepped portion 24 may be formed in the outer surface 26 adjacent the inlet 18 of the engine manifold 12. The engine manifold 12 may include an aperture (not shown) formed therein for coupling a sensor or other device thereto. Further, the engine manifold 12 may include a bracket (not shown) formed therewith for coupling a device or a support member thereto.

The inlet 18 is a finish of the engine manifold 12 having a substantially circular peripheral edge. A portion of the engine manifold 12 adjacent the inlet 18 may be adapted for receiving a resilient coupler (not shown) by having a stepped portion formed therein or having the outer surface 26 refined for receiving the resilient coupler. The resilient coupler may couple a fuel mixing device, an intake conduit, or an exhaust conduit to the inlet 18. Alternately, the inlet 18 may include a mounting flange (not shown) formed therewith.

The outlet 20 is a finish of the engine manifold 12 having a substantially circular peripheral edge. As shown, the resilient seal 16 is disposed on the stepped portion 24. A depth of a stepped wall 28 is substantially equal to a thickness of the resilient seal 16, affording the resilient seal 16 to sit “flush” with the outer surface 26 of the engine manifold 12.

The primary protuberance 22 is a body extending from the outer surface 26 of the engine manifold 12. As shown, the primary protuberance 22 has a substantially rectangular prism shape, the substantially rectangular prism shape having a plurality of rounded edges and a rounded transitionary surface formed between the primary protuberance 22 and the outer surface 26 of the engine manifold 12. However, other shapes such as a cylindrical prism, a bulbous protuberance, or any other shape may be used.

The primary protuberance 22 is formed adjacent the outlet 20 on an outer surface 26 of the engine manifold 12. As most clearly shown in FIG. 3, the stepped wall 28 forms a portion of the primary protuberance 22. Alternately, the primary protuberance 22 may be formed elsewhere on the outer surface 26 adjacent the outlet 20. The primary protuberance 22 is unitarily formed with the engine manifold 12, but may be formed separate the engine manifold 12 and coupled thereto using a fastener, a weld, or the like. As illustrated, the engine manifold 12 includes two primary protuberances 22 formed therewith, each of the protuberances 22 formed adjacent the outlets 20 of the engine manifold 12. The protuberances 22 are aligned with one another, the protuberances 22 similarly positioned on the engine manifold 12 with respect to the inlet 18.

The mounting collar 14 is a unitary body having a first inner surface 30, a second outer surface 32, a secondary protuberance 34, a manifold aperture 36 formed therethrough, and a fastening point 38 and a sealing groove 40 formed therein. The mounting collar 14 is typically formed by casting a metal such as a steel, but other processes such as stamping or machining may be used to form the mounting collar 14. A shape of a central portion of the mounting collar 14 is substantially circular, the central portion having two diametrically opposed rounded tabs extending therefrom, each of the rounded tabs meeting the central portion tangentially. Alternately, the mounting collar 14 may be any other shape and may have any number of tabs extending therefrom. As illustrated in FIG. 1, the manifold assembly 10 includes two mounting collars 14, each of the mounting collars 14 including one secondary protuberance 34 and two fastening points 38 formed therein. However, the mounting collar 14 may include any number of secondary protuberances 34 and any number of fastening points 38 formed therein. As shown in FIGS. 2 and 3, the mounting collar 14 is disposed on the engine manifold 12, the resilient seal 16 disposed therebetween. The mounting collar 14 is coupled to an engine block or cylinder head 42, the second outer surface 32 disposed adjacent the engine block or cylinder head 42. While the collar 14 may be mounted to either the engine block or the cylinder head, the following will utilize cylinder head 42.

The secondary protuberance 34 is a body extending from the first inner surface 30 of the mounting collar 14. As shown, the secondary protuberance 34 has a substantially rectangular prism shape, the substantially rectangular prism shape having a plurality of rounded edges and a rounded transitionary surface formed between the secondary protuberance 34 and the first inner surface 30 of the mounting collar 14. However, other shapes such as a cylindrical prism, a bulbous protuberance, or any other shape may be used. The secondary protuberance 34 is formed adjacent the manifold aperture 36 on the first inner surface 30 of the mounting collar 14. Alternately, the secondary protuberance 34 may be formed elsewhere on the first inner surface 30 adjacent the manifold aperture 36. The secondary protuberance 34 is unitarily formed with the mounting collar 14, but may be formed separate the mounting collar 14 and coupled thereto using a fastener, a weld, or the like.

The manifold aperture 36 is formed through the first inner surface 30 and the second outer surface 32. The first inner surface 30 is substantially parallel to the second outer surface 32. An aperture wall 44 defines the manifold aperture 36, the aperture wall 44 being substantially perpendicular to the first inner surface 30 and the second outer surface 32. An intersection of the aperture wall 44 and the first inner surface 30 forms a first peripheral edge 46 having a substantially circular shape. An intersection of the aperture wall 44 and the second outer surface 32 forms a second peripheral edge 48 having a substantially circular shape. A diameter of the second peripheral edge 48 is substantially equal to a diameter of the first peripheral edge 46.

The fastening point 38 is a perforation formed through the mounting collar 14. The fastening point 38 is a circular aperture formed outboard from the aperture wall 44 in each of the diametrically opposed rounded tabs. Alternately, the fastening point 38 may be a notch formed in a peripheral edge 50 of the mounting collar 14, a slot formed through the mounting collar 14, each of the tabs extending from the mounting collar 14, or any other portion of the mounting collar 14. The mounting collar 14 includes two fastening points 38 formed therethrough. As shown in FIG. 2, a threaded fastener is disposed through the fastening point 38 and into a threaded aperture (not shown) formed in the cylinder head 42, the threaded fastener coupling the mounting collar 14 to the cylinder head 42.

The sealing groove 40 is a substantially circular groove formed in the second outer surface 32 of the mounting collar 14. The sealing groove 40 is substantially concentric and formed outboard from the aperture wall 44 in the second outer surface 32. As shown in FIG. 3, when the mounting collar 14 is coupled to the cylinder head 42, an O-ring 52 is disposed between the mounting collar 14 and the cylinder head 42, in the sealing groove 40. The O-ring 52 is formed from an elastomeric material, however any other suitable material typically used to form seals may be used. A profile of the sealing groove 40 is substantially rectangular, however any other profile shape such as a semicircle may be used.

Alternately, the mounting collar 14 may include a sealing element molded to the sealing groove 40. The mounting collar 14 including the sealing element molded to the sealing groove 40 is formed by placing the mounting collar 14 within a set of molding dies corresponding to a shape of the mounting collar 14 including the sealing element. A moldable material is injected into the set of molding dies, the moldable material adhering to an exposed portion of the mounting collar 14 to form the mounting collar 14 including the sealing element molded to the sealing groove 40.

The resilient seal 16 is disposed between the engine manifold 12 and the mounting collar 14. As most clearly illustrated in FIGS. 1 and 3, the resilient seal 16 is an annulet having a substantially rectangular profile. The resilient seal 16 is formed from an elastomeric material, however any other suitable material typically used to form seals may be used. The resilient seal 16 is disposed on the stepped portion 24 of the engine manifold 12. A frictional force between the resilient seal 16 and the stepped portion 24 couples the resilient seal 16 thereto. The engine manifold 12 including the resilient seal 16 disposed thereon is disposed in the manifold aperture 36 of the mounting collar 14. A frictional force between the resilient seal 16 and the aperture wall 44 couples the resilient seal 16 to the mounting collar 14. Alternately, an adhesive disposed between the resilient seal 16 and the stepped portion 24 couples the resilient seal 16 thereto. Further, the resilient seal 16 may be a resilient seal molded to the stepped portion 24. The engine manifold 12 including the resilient seal 16 molded to the stepped portion 24 is formed by placing the engine manifold 12 within a set of molding dies (not shown) corresponding to a shape of the engine manifold 12 including the resilient seal 16. A moldable material is injected into the set of molding dies, the moldable material adhering to the stepped portion 24 to form the engine manifold 12 including the resilient seal 16 molded to the stepped portion 24.

Still further, the resilient seal 16 may be a resilient seal molded to the stepped portion 24 and to the mounting collar 14, coupling the mounting collar 14 to the engine manifold 12. The resilient seal 16 molded to the stepped portion 24 and to the mounting collar 14 is formed by placing the mounting collar 14 and the engine manifold 12 within a set of molding dies (not shown) corresponding to a shape of the mounting collar 14 and the engine manifold 12 including the resilient seal 16 molded to the stepped portion 24 and to the mounting collar 14. A moldable material is injected into the set of molding dies, the moldable material adhering to the stepped portion 24 and to the aperture wall 44 to form the manifold assembly 10 including the resilient seal 16 molded to the stepped portion 24 and to the mounting collar 14.

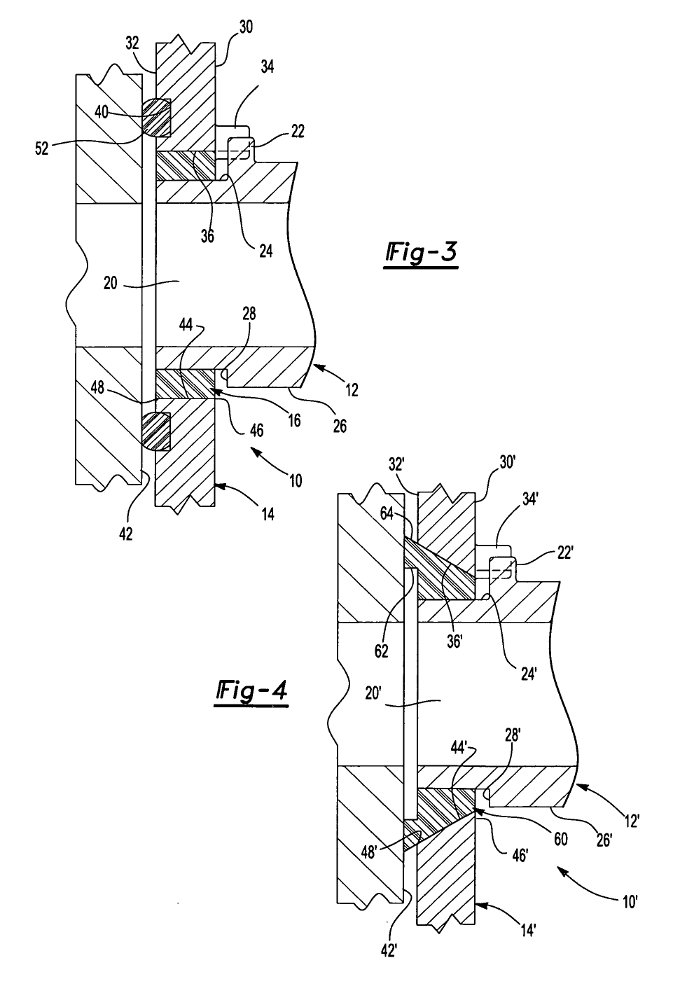

FIG. 4 shows an alternative embodiment of the manifold assembly for an engine. Similar structural features of the manifold assembly include the same reference numeral and a prime (′) symbol.

The mounting collar 14′ is a unitary body having a first inner surface 30′, a second outer surface 32′, a secondary protuberance 34′, a manifold aperture 36′ formed therethrough, and a fastening point (not shown) formed therein. The mounting collar 14′ is typically formed by stamping a metal such as a steel, but other processes such as machining may be used to form the mounting collar. As illustrated, the engine manifold 12′ includes one secondary protuberance 34′ disposed thereon. However, the mounting collar 14′ may include any number of secondary protuberances 34′. As shown in FIG. 4, the mounting collar 14′ is disposed on the engine manifold 12′, a resilient seal 60 including a unitarily formed interfacial seal 62 disposed between the mounting collar 14′ and the engine manifold 12′. The mounting collar 14′ is coupled to a cylinder head 42′, the second outer surface 32′ disposed adjacent the cylinder head 42′.

The manifold aperture 36′ is formed through the first inner surface 30′ and the second outer surface 32′. The first inner surface 30′ is substantially parallel to the second outer surface 32′. An aperture wall 44′ defines the manifold aperture 36′, the aperture wall 44′ being oblique to the first inner surface 30′ and the second outer surface 32′. An intersection of the aperture wall 44′ and the first inner surface 30′ forms a first peripheral edge 46′ having a substantially circular shape. An intersection of the aperture wall 44′ and the second outer surface 32′ forms a second peripheral edge 48′ having a substantially circular shape. A diameter of the second peripheral edge 48′ is greater than a diameter of the first peripheral edge 46′.

The resilient seal 60 including the unitarily formed interfacial seal 62 is disposed between the engine manifold 12′ and the mounting collar 14′. The resilient seal 60 is a tapered annulet having a thickness substantially corresponding a thickness of the mounting collar 14′. The unitarily formed interfacial seal 62 is a portion of the resilient seal 60 extending therefrom adjacent the second outer surface 32′. The unitarily formed interfacial seal 62 has an inner diameter greater than the stepped portion 24′ and an outer diameter greater than the diameter of the second peripheral edge 48′. As shown in FIG. 4, a portion of the unitarily formed interfacial seal 62 extends in a parallel manner from an outer wall 64 of the resilient seal 60. The outer wall 64 is oblique to the first inner surface 30′ and the second outer surface 32′ and substantially corresponds to a shape of the aperture wall 44′. The unitarily formed interfacial seal 62 of the resilient seal 60 is disposed between the mounting collar 14′ and the cylinder head 42′ the mounting collar 14′ is coupled to. The unitarily formed interfacial seal 62 of the resilient seal 60 protrudes beyond the second peripheral edge 48′. The resilient seal 16′ including the unitarily formed interfacial seal 62 is formed from an elastomeric material, however any other suitable material typically used to form seals may be used. The resilient seal 60 including the unitarily formed interfacial seal 62 is molded to the stepped portion 24′ and to the mounting collar 14′, coupling the mounting collar 14 to the engine manifold 12′. The resilient seal 60 including the unitarily formed interfacial seal 62 molded to the stepped portion 24′ and to the mounting collar 14′ is formed by placing the mounting collar 14′ and the engine manifold 12′ within a set of molding dies (not shown). The set of molding dies correspond to a shape of the mounting collar 14′ and the engine manifold 12′ including the resilient seal 60 including the unitarily formed interfacial seal 62 molded to the stepped portion 24′ and to the mounting collar 14′. A moldable material is injected into the set of molding dies, the moldable material adhering to the stepped portion 24′ and to the aperture wall 44′ to form the manifold assembly 10′ including the resilient seal 60 including the unitarily formed interfacial seal 62 molded to the stepped portion 24′ and to the mounting collar 14′.

In use, the manifold assembly 10, 10′ for the engine minimizes a number of components of the manifold assembly 10, 10′ and minimizes a time of assembly of the manifold assembly 10, 10′. The resilient seal 16, 60 disposed between the mounting collar 14, 14′ and the engine manifold 12, 12′ simplifies a proper alignment of the mounting collar 14, 14′ and the engine manifold 12, 12′ when coupling the manifold assembly 10, 10′ to the cylinder head 42, 42′. Further, the manifold assembly 10, 10′ militates against a rotation of the engine manifold 12, 12′. As shown in FIGS. 2-4, the primary protuberance 22, 22′ abuts the secondary protuberance 34, 34′. When the engine manifold 12, 12′ or any attachment thereto is subjected to a force that would result in the rotation of the engine manifold 12, 12′ with respect to the mounting collar 14, 14′, abutment of the primary protuberance 22, 22′ and the secondary protuberance 34, 34′ militates against a rotation of the engine manifold 12, 12′. Accordingly, damage to the resilient seal 16, 60 that may result due to movement between the engine manifold 12, 12′ and the mounting collar 14, 14′ is minimized.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A manifold assembly for an engine, comprising:
an engine manifold having an inlet, at least one outlet, and a primary protuberance formed adjacent the at least one outlet on an outer surface of said engine manifold;
a mounting collar having a secondary protuberance, said mounting collar disposed adjacent the at least one outlet of said engine manifold; and
a resilient seal disposed between said engine manifold and said mounting collar, wherein the primary protuberance abuts the secondary protuberance to militate against a rotation of said engine manifold with respect to said mounting collar.

2. The manifold assembly for an engine of claim 1, wherein said mounting collar includes a manifold aperture formed therethrough.

3. The manifold assembly for an engine of claim 2, wherein the manifold aperture is defined by an aperture wall, the aperture wall being substantially perpendicular to a first inner surface and a second outer surface of said mounting collar.

4. The manifold assembly for an engine of claim 3, wherein the secondary protuberance is disposed on the first inner surface of said mounting collar.

5. The manifold assembly for an engine of claim 3, wherein the second outer surface of said mounting collar includes a sealing groove for receiving an O-ring, the sealing groove having a substantially circular shape and substantially concentric and formed outboard from the aperture wall.

6. The manifold assembly for an engine of claim 2, wherein the manifold aperture is defined by an aperture wall, the aperture wall being oblique to a first inner surface and a second outer surface of said mounting collar.

7. The manifold assembly for an engine of claim 6, wherein a first peripheral edge of said mounting collar is formed by an intersection of the aperture wall and the first inner surface and has a substantially circular shape and a first peripheral edge diameter and a second peripheral edge of said mounting collar is formed by an intersection of the aperture wall and the second outer surface and has a substantially circular shape and a second peripheral edge diameter, the second peripheral edge diameter greater than the first peripheral edge diameter.

8. The manifold assembly for an engine of claim 6, wherein said resilient seal includes an interfacial seal unitarily formed therewith, the interfacial seal disposed between said mounting collar and a cylinder head said mounting collar is coupled to.

9. The manifold assembly for an engine of claim 1, wherein a cross-sectional shape of said engine manifold adjacent the at least one outlet is substantially ring shaped and a portion of said engine manifold has a diameter less than a remaining portion of said engine manifold.

10. The manifold assembly for an engine of claim 1, wherein said mounting collar is coupled to a cylinder head, and an O-ring is disposed between said mounting collar and the cylinder head.

11. The manifold assembly for an engine of claim 1, wherein said resilient seal includes an interfacial seal unitarily formed therewith, the interfacial seal disposed between said mounting collar and a cylinder head said mounting collar is coupled to.

12. The manifold assembly for an engine of claim 1, wherein a portion of the secondary protuberance is formed by an aperture wall, the aperture wall defining a manifold aperture through said mounting collar.

13. The manifold assembly for an engine of claim 1, wherein said engine manifold includes a stepped portion formed in the outer surface thereof adjacent the at least one outlet of said engine manifold.

14. The manifold assembly for an engine of claim 1, wherein said mounting collar includes two fastening points formed therein, the two fastening points formed outboard from an aperture wall, the aperture wall defining a manifold aperture through said mounting collar.

15. The manifold assembly for an engine of claim 1, wherein the primary protuberance and the secondary protuberance are rounded bodies respectively extending from the outer surface of said engine manifold and a first inner surface of said mounting collar.

16. A manifold assembly for an engine, comprising:
an engine manifold having an inlet, at least one outlet, and a primary protuberance formed adjacent the at least one outlet on an outer surface of said engine manifold;
a mounting collar disposed on said engine manifold adjacent the at least one outlet, comprising:
a first inner surface;
a second outer surface substantially parallel to said first inner surface;
a manifold aperture defined by an aperture wall formed through said first inner surface and said second outer surface of said mounting collar;
a secondary protuberance disposed on said first inner surface of said mounting collar, wherein the aperture wall is substantially perpendicular to said first inner surface and said second outer surface of said mounting collar;
a sealing groove formed in the second outer surface of said mounting collar, said sealing groove having a substantially circular shape and substantially concentric and formed outboard from the aperture wall; and
a resilient seal molded between said engine manifold and said mounting collar, wherein said resilient seal couples said engine manifold to said mounting collar, the primary protuberance abuts the secondary protuberance to militate against a rotation of said engine manifold with respect to said mounting collar.

17. The manifold assembly for an engine of claim 16, comprising an O-ring disposed in said sealing groove and a cylinder head the mounting collar is coupled to, wherein the O-ring forms an interfacial seal between said mounting collar and the cylinder head.

18. The manifold assembly for an engine of claim 16, wherein said engine manifold includes a stepped portion formed in the outer surface thereof adjacent the at least one outlet of said engine manifold, said resilient seal molded between the stepped portion of said engine manifold and said mounting collar.

19. A manifold assembly for an engine, comprising:
an engine manifold having an inlet, at least one outlet, and a primary protuberance formed adjacent the at least one outlet on an outer surface of said engine manifold;
a mounting collar disposed on said engine manifold adjacent the at least one outlet, comprising:
a first inner surface;
a second outer surface substantially parallel to said first inner surface;
a manifold aperture defined by an aperture wall formed through said first inner surface and said second outer surface of said mounting collar;
a secondary protuberance disposed on said first inner surface of said mounting collar, wherein the aperture wall is oblique to said first inner surface and said second outer surface of said mounting collar, a first peripheral edge of said mounting collar is formed by an intersection of the aperture wall and said first inner surface and has a substantially circular shape and a first peripheral edge diameter and a second peripheral edge of said mounting collar is formed by an intersection of the aperture wall and said second outer surface and has a substantially circular shape and a second peripheral edge diameter, the second peripheral edge diameter greater than the first peripheral edge diameter; and
a resilient seal molded between said engine manifold and said mounting collar, wherein said resilient seal couples said engine manifold to said mounting collar, said resilient seal includes an interfacial seal unitarily formed therewith, the interfacial seal protrudes beyond the second peripheral edge, and the primary protuberance abuts the secondary protuberance to militate against a rotation of said engine manifold with respect to said mounting collar.

20. The manifold assembly for an engine of claim 19, wherein said engine manifold includes a stepped portion formed in the outer surface thereof adjacent the at least one outlet of said engine manifold, said resilient seal molded between the stepped portion of said engine manifold and said mounting collar.
